(19) United States
(12) Patent Application Publication
(10) Pub. No.: US 2003/0126394 A1
(43) Pub. Date: Jul. 3, 2003

(54) System and method for remote configuration of data storage space

(75) Inventor: Thomas P. Fowler, New Brighton, MN (US)

Correspondence Address: Timothy R. Schulte, Storage Technology Corporation, One StorageTek Drive, MS-4309, Louisville, CO, 80028-4309, US

(73) Assignee: Storage Technology Corporation, Louisville, CO (US)

(21) Appl. No.: 10/034,068

(22) Filed: Dec. 27, 2001

(51) Int. Cl. G06F 13/00

(52) U.S. Cl. 711/170

(57) ABSTRACT

A system and method for remotely configuring storage space in multiple storage devices. The multiple storage devices include free storage space and storage space allocated to a user for storing data from the user, where the user is located at a site remote from the storage devices. A portion of the free storage space is automatically transferred to the allocated storage space in response to a request by the remote user to increase the size of the allocated storage space.

### BACKGROUND OF THE INVENTION

1. Field of the Invention

The present invention relates to a system and method for remote configuration of data storage space.

2. Background

Storage service provider (SSP) companies provide data storage services to multiple remote customers. More particularly, SSP companies maintain a plurality of data storage devices, such as magnetic disk drives, that are used by the SSP's remote customers for storage and retrieval of the customers' data.

In order to improve data management, an SSP restricts those storage devices from which a particular customer may take storage space to a subset of all possible storage devices. This may be accomplished, for example, by grouping multiple disks into sets or pools that are allocated to a particular customer. A specified set of physical disks may be abstracted as a single entity. In such a fashion, one or more logical or “virtual” disks may be created. Such virtual disks may be presented to a customer or user, while multiple pooled physical disks specified by the SSP are employed for actual storage of the user's data.

In that regard, it is well known to use disk pooling in a Redundant Array of Independent/Inexpensive Disks (RAID). RAID devices typically include multiple physical disk drives, as well as an internal controller which pools the multiple disks in order to allow a single virtual disk to be presented to a user. In that same regard, a virtual volume manager may be provided in communication with one or more RAID devices by an SSP in order to manage data storage and retrieval for a plurality of remote customers. Such a virtual volume manager takes a large segment of physical data storage space, such as disk space, and presents such storage space to a user as numerous smaller virtual storage devices, such as virtual disks.

Using an SSP, a customer may reduce or eliminate its investment in data storage devices and any accompanying support that may be needed for such devices. The use of an SSP also provides such a customer increased flexibility. That is, the customer may obtain as much or as little data storage space as the customer may need at any given time. If a customer's need for data storage space increases, additional data storage space can be allocated by the SSP from the plurality of data storage devices maintained by the SSP to that customer for storage and retrieval of the customer's data. Similarly, as a customer's need for data storage space decreases, the amount of data storage space allocated by the SSP to that customer from the plurality of data storage devices maintained by the SSP can be reduced.

In that regard, however, to expand or reduce its allocated data storage space, an SSP customer must manually contact and consult the SSP. A staff member at the SSP's data center must then manually take the steps necessary to increase or reduce the data storage space allocated to that user. This includes ensuring that the customer's increased or reduced data storage space is accurately reflected for accounting and billing purposes.

Thus, there exists a need for a system and method for remote configuration of data storage space. Such a system and method would provide for such remote configuration automatically upon a request by a user. That is, such a system and method would allow an SSP customer the direct ability to adjust its allocated data storage space on demand. Such a system and method would further allow the SSP customer to do so autonomously, without the need for intervention by the SSP's data center staff.

### SUMMARY OF THE INVENTION

Accordingly, it is an object of the present invention to provide a system and method for remote configuration of data storage space.

According to the present invention, then, a system is provided for remotely configuring storage space. The system comprises a plurality of storage devices, the plurality of storage devices having storage space comprising free storage space and allocated storage space, wherein the allocated storage space has a size and is to be allocated to a user for storing data from the user, the user to be located at a site remote from the plurality of storage devices. The system further comprises a controller to be provided in communication with the plurality of storage devices and the remote user for automatically transferring a portion of the free storage space to the allocated storage space in response to a request by the remote user to increase the size of the allocated storage space.

Also according to the present invention, a method is provided for remotely configuring storage space. The method comprises providing a plurality of storage devices, the plurality of storage devices having storage space comprising free storage space and allocated storage space, wherein the allocated storage space has a size and is to be allocated to a user for storing data from the user, the user to be located at a site remote from the plurality of storage devices. The method further comprises providing a controller to be provided in communication with the plurality of storage devices and the remote user for automatically transferring a portion of the free storage space to the allocated storage space in response to a request by the remote user to increase the size of the allocated storage space.

Still further according to the present invention, a method is provided for remotely configuring storage space in a system having a plurality of storage devices, the plurality of storage devices having storage space comprising free storage space and allocated storage space, wherein the allocated storage space has a size and is to be allocated to a user for storing data from the user, the user to be located at a site remote from the plurality of storage devices. The method comprises providing a controller to be provided in communication with the plurality of storage devices and the remote user for automatically transferring a portion of the free storage space to the allocated storage space in response to a request by the remote user to increase the size of the allocated storage space.

These and other features and advantages of the present invention are readily apparent from the following detailed description of the present invention when taken in connection with the accompanying drawings.

### BRIEF DESCRIPTION OF THE DRAWINGS

FIG. 1 is a simplified block diagram including the system for remotely configuring storage space of the present invention;

FIG. 2 is a simplified, exemplary flowchart including one embodiment of the method for remotely configuring storage space of the present invention; and

FIG. 3 is a simplified, exemplary flowchart including another embodiment of the method for remotely configuring storage space of the present invention.

### DETAILED DESCRIPTION OF THE PREFERRED EMBODIMENT(S)

Referring now to the Figures, the preferred embodiments of the present invention will now be described in detail. As previously noted, SSP companies provide data storage services to multiple remote customers. More particularly, SSP companies maintain a plurality of data storage devices, such as magnetic disk drives, that are used by the SSP's remote customers for storage and retrieval of the customer's data.

As also noted previously, in order to improve data management, an SSP restricts those storage devices from which a particular customer may take storage space to a subset of all possible storage devices. This may be accomplished, for example, by grouping multiple disks into sets or pools that are allocated to a particular customer. A specified set of physical disks may be abstracted as a single entity. In such a fashion, one or more logical or “virtual” disks may be created. Such virtual disks may be presented to a customer or user, while multiple pooled physical disks specified by the SSP are employed for actual storage of the user's data.

In that regard, as described above, it is well known to use disk pooling in a Redundant Array of Independent/Inexpensive Disks (RAID). RAID devices typically include multiple physical disk drives, as well as an internal controller which pools the multiple disks in order to allow a single virtual disk to be presented to a user. In that same regard, a virtual volume manager may be provided in communication with one or more RAID devices by an SSP in order to manage data storage and retrieval for a plurality of remote customers as described above. Such a virtual volume manager takes a large segment of physical data storage space, such as disk space, and presents such storage space to a user as numerous smaller virtual storage devices, such as virtual disks.

As also described above, using an SSP, a customer may reduce or eliminate its investment in data storage devices and any accompanying support that may be needed for such devices. The use of an SSP also provides such a customer increased flexibility. That is, the customer may obtain as much or as little data storage space as the customer may need at any given time. If a customer's need for data storage space increases, additional data storage space can be allocated by the SSP from the plurality of data storage devices maintained by the SSP to that customer for storage and retrieval of the customer's data. Similarly, as a customer's need for data storage space decreases, the amount of data storage space allocated by the SSP to that customer from the plurality of data storage devices maintained by the SSP can be reduced.

However, as noted above, to expand or reduce its allocated data storage space, an SSP customer must manually contact and consult the SSP. A staff member at the SSP's data center must then manually take the steps necessary to increase or decrease the data storage space allocated to that user. This includes ensuring that the customer's increased or reduced data storage space is accurately reflected for accounting and billing purposes.

Thus, there exists a need for a system and method for remote configuration of data storage space. Such a system and method would provide for such remote configuration automatically upon a request by a user. That is, such a system and method would allow an SSP customer the direct ability to adjust its allocated data storage space on demand. Such a system and method would further allow the SSP customer to do so autonomously, without the need for intervention by the SSP's data center staff.

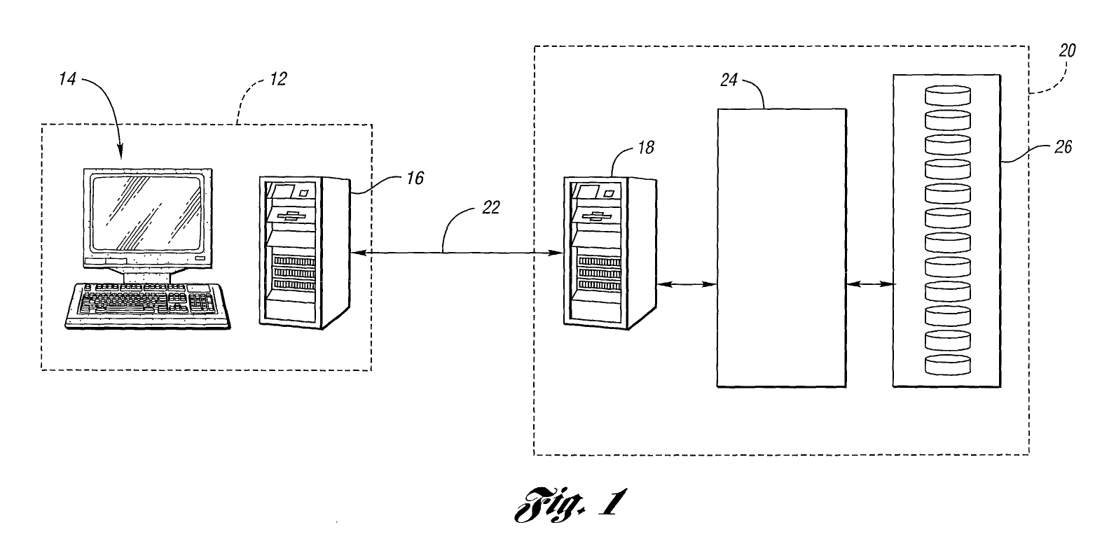

Referring now to FIG. 1, a simplified block diagram including the system for remotely configuring storage space of the present invention is shown, denoted generally by reference numeral 10. As seen therein, a remote user site (12), such as for an SSP customer, includes a workstation (14), which may include a server (16). Remote user workstation (14) is provided in communication with a workstation (18) at a data center site (20), such as may be maintained by an SSP. In that regard, such communication between workstations (14, 18) is preferably provided via a communication path (22) suitable to allow workstation (14) to establish a secure connection with workstation (18) at data center site (20). It should also be noted that workstation (18) may comprise a server.

Still referring to FIG. 1, workstation (18) at data center site (20) is itself provided in communication with storage device manager (24). In turn, storage device manager (24) is provided in communication with at least one array (26) of data storage devices. Storage device manager (24) is preferably a virtual volume manager of the type previously described for use by SSPs to manage data storage and retrieval for a plurality of remote SSP customers. That is, storage device manager (24) preferably presents at least one virtual storage volume (not shown) to the remote user for use in storage and retrieval of the user's data. The virtual storage volumes are mapped to the storage space on the plurality of storage devices that has been allocated to the remote user, as described below.

Array (26) may be a RAID device of the type described above, or other storage devices, such as magnetic tape devices. Array (26) comprises data storage space that itself comprises free data storage space and data storage space that has been allocated to the remote user (not shown) at remote user site (12), for use in storage and retrieval of the user's data. The free data storage space preferably comprises a pool as previously described, which may be referred to as a free data storage space pool. Similarly, the allocated data storage space also preferably comprise a pool as previously described, or a Logical Unit Number (LUN). In that regard, storage device manager (24) is preferably a single, centralized management platform for the entire pool of data storage space (i.e., free and allocated). In such a fashion, storage device manager (24) is more easily maintained, and provides for improved security.

Referring still to FIG. 1, in operation, storage device manager (24), in concert with standard remote access techniques, allow a remote user, such as an SSP customer, to directly and automatically enlarge or reduce the data storage space which has been allocated to that user. In that regard, an Application Programming Interface (API) is preferably provided that allows the remote user (not shown) limited access to the administrative functions of storage device manager (24), including accounting and billing routines, for such a purpose.

More particularly, using workstation (14) at remote user site (12), which is linked to communication path (22), a remote user (not shown) is allowed to establish a secure connection with workstation (18) at data center site (20). A device manager program (not shown), preferably residing on workstation (18) at data center site (20), provides limited access, preferably under password control, to the administrative functions of storage device manager (24). Under control of this program, and the aforementioned supporting API, the remote user (not shown) is allowed to request directly from storage device manager (24) an increase or a reduction in the amount of data storage space in array (26) that has been allocated to that user. In that regard, API acts as a conduit allowing a remote user to interface with the device manager program. Preferably, API resides on workstation (18) at data center site (20). In one embodiment, API may support web-based access by remote users. That is, a remote user (not shown) at remote user site (12) may access an appropriate web-site where, using API and the device manager program, the remote user could allocate or de-allocate storage space for use by that remote user.

In the case of a request by the remote user for an increase in the amount of data storage space allocated to that user, storage device manager (24) automatically transfers free data storage space in the attached array (26) from the free data storage space pool to the allocated storage space allocated to the remote user (not shown) (i.e., to the pool or LUN reserved for the requesting remote user). Storage device manager (24) also preferably includes accounting and billing routines that automatically take the remote user's requested increase in data storage space into account. Significantly, at no time during such operation of the system (10) of the present invention is any data center staff member (not shown) either consulted or contacted, except in the case where the user's request for increased data storage space cannot currently be satisfied due to insufficient resources.

Thus, as described above, and with continuing reference to FIG. 1, the system for remotely configuring storage space of the present invention comprises a plurality of storage devices, such as array (26). The plurality of storage devices have storage space thereon comprising free storage space and allocated storage space, where the allocated storage space is allocated to a user for storing data from the user. The user is located at a site (12) remote from the site (20) of the plurality of storage devices.

The system for remotely configuring storage space of the present invention further comprises a controller to be provided in communication with the plurality of storage devices and the remote user for automatically transferring a portion of the free storage space to the allocated storage space in response to a request by the remote user to increase the size of the allocated storage space. In that regard, the controller preferably comprises software, such as the API and device manager program previously described. As an alternative to such a computer program, however, hardware, such as a processor, or a combination of hardware and software could also be used. The computer program may be provided on a server, such as workstation (18), located at a site, such as data center site (20), remote from the user. The plurality of storage devices may also be located at the server site (20).

Still further, the system for remotely configuring storage space of the present invention may also comprise a storage device manager, such as storage device manager (24), to be provided in communication with the remote user and the plurality of storage devices. The storage device manager preferably presents a plurality of virtual storage volumes (not shown) to the remote user for use in storage and retrieval of the user's data. In that regard, the plurality of virtual storage volumes are mapped to the allocated storage space of the plurality of storage devices. Moreover, it should be noted that the plurality of storage devices may be part of a storage network (not shown), and may comprise a plurality of disk storage devices, although other storage devices, such as magnetic tape devices, could also be used.

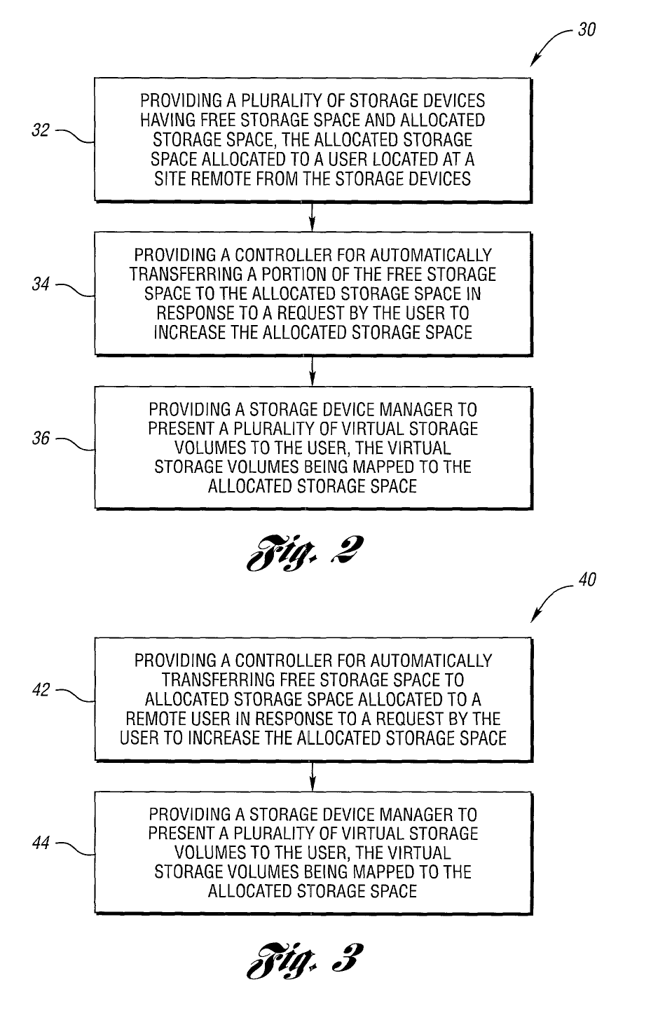

Referring now to FIG. 2, a simplified, representative flow chart depicting one embodiment of the method for remote configuration of data storage space of the present invention is shown, denoted generally by reference numeral 30. As seen therein, the method (30) comprises providing (32) a plurality of storage devices, the plurality of storage devices having storage space comprising free storage space and allocated storage space, wherein the allocated storage space has a size and is to be allocated to a user for storing data from the user, the user to be located at a site remote from the plurality of storage devices. The method (30) further comprises providing (34) a controller to be provided in communication with the plurality of storage devices and the remote user for automatically transferring a portion of the free storage space to the allocated storage space in response to a request by the remote user to increase the size of the allocated storage space.

As previously described, the controller means may comprise a computer program, a processor, or a combination of both. The computer program may be provided on a server located at a site remote from the user, and the plurality of storage devices may be located at the server site. The method (30) may further comprise providing (36) a storage device manager to be provided in communication with the remote user and the plurality of storage devices, wherein the storage device manager presents a plurality of virtual storage volumes to the remote user for use in storage and retrieval of the user data, and the plurality of virtual storage volumes are mapped to the allocated storage space of the plurality of storage devices. The plurality of storage devices may be part of a storage network, and may comprise a plurality of disk storage devices, although other storage devices, such as magnetic tape devices, could also be used.

Referring next to FIG. 3, a simplified, representative flow chart depicting another embodiment of the method for remote configuration of data storage space of the present invention is shown, denoted generally by reference numeral 40. The method (40) is for remotely configuring storage space in a system having a plurality of storage devices, the plurality of storage devices having storage space comprising free storage space and allocated storage space, wherein the allocated storage space has a size and is to be allocated to a user for storing data from the user, the user to be located at a site remote from the plurality of storage devices. As seen in FIG. 3, the method comprises providing (42) a controller to be provided in communication with the plurality of storage devices and the remote user for automatically transferring a portion of the free storage space to the allocated storage space in response to a request by the remote user to increase the size of the allocated storage space.

Once again, as previously described, the controller may comprise a computer program, a processor, or a combination of both. The computer program may be provided on a server located at a site remote from the user, and the plurality of storage devices may be located at the server site. The method (40) may further comprise providing (44) a storage device manager to be provided in communication with the remote user and the plurality of storage devices, wherein the storage device manager presents a plurality of virtual storage volumes to the remote user for use in storage and retrieval of the user data, and the plurality of virtual storage volumes are mapped to the allocated storage space of the plurality of storage devices. The plurality of storage devices may be part of a storage network, and may comprise a plurality of disk storage devices, although other storage devices, such as magnetic tape devices, could also be used.

It should be noted that the simplified flowcharts depicted in FIGS. 2 and 3 are exemplary of the method of the present invention. In that regard, the steps of such method may be executed in sequences other than those shown in FIGS. 2 and 3, including the execution of one or more steps simultaneously.

As is readily apparent from the foregoing description, the present invention provides a system and method for remote configuration of data storage space. The system and method of the present invention provide for such remote configuration automatically upon a request by a user. That is, the system and method of the present invention allow an SSP customer the direct ability to adjust its allocated data storage space on demand. The system and method of the present invention further allow the SSP customer to do so autonomously, without the need for intervention by the SSP's data center staff.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for remotely configuring storage space, the system comprising:
a plurality of storage devices, the plurality of storage devices having storage space comprising free storage space and allocated storage space, wherein the allocated storage space has a size and is to be allocated to a user for storing data from the user, the user to be located at a site remote from the plurality of storage devices; and
a controller to be provided in communication with the plurality of storage devices and the remote user for automatically transferring a portion of the free storage space to the allocated storage space in response to a request by the remote user to increase the size of the allocated storage space.

2. The system of claim 1 wherein the controller comprises a computer program.

3. The system of claim 1 wherein the controller comprises a processor.

4. The system of claim 1 wherein the request by the remote user is to the controller.

5. The system of claim 2 wherein the computer program is to be provided on a server located at a site remote from the user, and wherein the plurality of storage devices are located at the server site.

6. The system of claim 1 further comprising a storage device manager to be provided in communication with the remote user and the plurality of storage devices, wherein the storage device manager presents a plurality of virtual storage volumes to the remote user for use in storage and retrieval of the user data, and the plurality of virtual storage volumes are mapped to the allocated storage space of the plurality of storage devices.

7. The system of claim 1 wherein the plurality of storage devices are part of a storage network.

8. The system of claim 1 wherein the plurality of storage devices comprises a plurality of disk storage devices.

9. The system of claim 1 wherein the controller is further for automatically transferring a portion of the allocated storage space to the free storage space in response to a request by the remote user to decrease the size of the allocated storage space.

10. The system of claim 9 wherein the request by the remote user is to the controller.

11. A method for remotely configuring storage space, the method comprising:
providing a plurality of storage devices, the plurality of storage devices having storage space comprising free storage space and allocated storage space, wherein the allocated storage space has a size and is to be allocated to a user for storing data from the user, the user to be located at a site remote from the plurality of storage devices; and
providing a controller to be provided in communication with the plurality of storage devices and the remote user for automatically transferring a portion of the free storage space to the allocated storage space in response to a request by the remote user to increase the size of the allocated storage space.

12. The method of claim 11 wherein the controller comprises a computer program.

13. The method of claim 11 wherein the controller comprises a processor.

14. The method of claim 11 wherein the request by the remote user is to the controller.

15. The method of claim 12 wherein the computer program is to be provided on a server located at a site remote from the user, and wherein the plurality of storage devices are located at the server site.

16. The method of claim 11 further comprising providing a storage device manager to be provided in communication with the remote user and the plurality of storage devices, wherein the storage device manager presents a plurality of virtual storage volumes to the remote user for use in storage and retrieval of the user data, and the plurality of virtual storage volumes are mapped to the allocated storage space of the plurality of storage devices.

17. The method of claim 11 wherein the plurality of storage devices are part of a storage network.

18. The method of claim 11 wherein the plurality of storage devices comprises a plurality of disk storage devices.

19. The method of claim 11 wherein the controller is further for automatically transferring a portion of the allocated storage space to the free storage space in response to a request by the remote user to decrease the size of the allocated storage space.

20. The method of claim 19 wherein the request by the remote user is to the controller.

21. A method for remotely configuring storage space in a system having a plurality of storage devices, the plurality of storage devices having storage space comprising free storage space and allocated storage space, wherein the allocated storage space has a size and is to be allocated to a user for storing data from the user, the user to be located at a site remote from the plurality of storage devices, the method comprising:
providing a controller to be provided in communication with the plurality of storage devices and the remote user for automatically transferring a portion of the free storage space to the allocated storage space in response to a request by the remote user to increase the size of the allocated storage space.

22. The method of claim 21 wherein the controller comprises a computer program.

23. The method of claim 21 wherein the controller comprises a processor.

24. The method of claim 21 wherein the request by the remote user is to the controller.

25. The method of claim 22 wherein the computer program is to be provided on a server located at a site remote from the user, and wherein the plurality of storage devices are located at the server site.

26. The method of claim 21 further comprising providing a storage device manager to be provided in communication with the remote user and the plurality of storage devices, wherein the storage device manager presents a plurality of virtual storage volumes to the remote user for use in storage and retrieval of the user data, and the plurality of virtual storage volumes are mapped to the allocated storage space of the plurality of storage devices.

27. The method of claim 21 wherein the plurality of storage devices are part of a storage network.

28. The method of claim 21 wherein the plurality of storage devices comprises a plurality of disk storage devices.

29. The method of claim 21 wherein the controller is further for automatically transferring a portion of the allocated storage space to the free storage space in response to a request by the remote user to decrease the size of the allocated storage space.

30. The method of claim 29 wherein the request by the remote user is to the controller.

31. In a storage system having a plurality of storage devices, the plurality of storage devices having storage space comprising free storage space and allocated storage space, the allocated storage space having a size and being allocated to a remote user for storing data from the user, a method for configuring storage space, comprising:
automatically receiving a request from the user to increase the size of the allocated storage space; and
automatically transferring a portion of the free storage space to the allocated storage space in response to the request by the user to increase the size of the allocated storage space.

32. The method of claim 31 wherein the storage system also includes a controller for use in automatically transferring a portion of the free storage space to the allocated storage space.

33. The method of claim 32 wherein the controller is also for use in receiving the request by the user to increase the size of the allocated storage space.

34. The method of claim 31 wherein the storage system also includes a storage device manager in communication with the user and the plurality of storage devices, wherein the storage device manager presents a plurality of virtual storage volumes to the user for use in storage and retrieval of the user data, and the plurality of virtual storage volumes are mapped to the allocated storage space of the plurality of storage devices.

35. The method of claim 31 wherein the plurality of storage devices are part of a storage network.

36. In a storage system having a plurality of storage devices, the plurality of storage devices having storage space comprising free storage space and allocated storage space, the allocated storage space having a size and being allocated to a remote user for storing data from the user, a method for configuring storage space, comprising:
automatically receiving a request from the user to decrease the size of the allocated storage space; and
automatically transferring a portion of the allocated storage space to the free storage space in response to the request by the user to decrease the size of the allocated storage space.

37. The method of claim 36 wherein the storage system also includes a controller for use in automatically transferring a portion of the free storage space to the allocated storage space.

38. The method of claim 37 wherein the controller is also for use in receiving the request by the user to increase the size of the allocated storage space.

39. The method of claim 36 wherein the storage system also includes a storage device manager in communication with the user and the plurality of storage devices, wherein the storage device manager presents a plurality of virtual storage volumes to the user for use in storage and retrieval of the user data, and the plurality of virtual storage volumes are mapped to the allocated storage space of the plurality of storage devices.

40. The method of claim 36 wherein the plurality of storage devices are part of a storage network.
